(19) United States
(12) Patent Application Publication
(10) Pub. No.: US 2022/0325560 A1
(43) Pub. Date: Oct. 13, 2022

(54) MODULAR FLOOR PANEL LATCHING SYSTEM

(71) Applicant: Wutpool, Inc, Blaine, MN (US)

(72) Inventors: Scott Uram, Wyoming, MN (US); Michael A. Taylor, Cambridge, MN (US); Andy Schlenker, East Bethel, MN (US)

(73) Assignee: Wutpool, Inc, Blaine, MN (US)

(21) Appl. No.: 17/229,614

(22) Filed: Apr. 13, 2021

(51) Int. Cl. E05B 65/00; E04H 4/08; E05B 9/00; E06B 9/06

(52) U.S. Cl. CPC E05B 65/006; E04H 4/08; E05B 9/002; E06B 9/0638

(57) ABSTRACT

A latch system that attaches to a retractable load bearing pool cover. The latch system interconnects deployable and retractable load-bearing floor panels or pool cover panels that may be separable into individual sections for compact vertical stacking and storage when the panels are retracted.

### CROSS-REFERENCE TO RELATED APPLICATIONS

Not Applicable

### Federal Sponsorship

Not Applicable

Joint Research Agreement:

Not Applicable

### TECHNICAL FIELD

The present invention relates generally to deployable and retractable panels, and more particularly to a deployable and retractable load-bearing pool cover that may be separable into individual sections for compact vertical stacking and storage thereof when the cover is in a retracted condition. Further, the present invention relates to a panel latching system sufficient to allow the panels to be alternatively used as load bearing flooring when deployed.

### BACKGROUND

Structures for covering surfaces or voids take on numerous forms and arrangements. Typically, covers are used to conceal and/or protect underlying surfaces. Rarely, however, are such covers capable of concealing and/or protecting as well as for bearing loads placed thereupon. An example for illustrative purposes are pool covers used to cover at or below-grade swimming pools. Most commonly, swimming pool covers are fabricated from a relatively flexible material, and may be deployed into a covering condition through, for example, unwinding the cover material from a roll. Flexible swimming pool covers are widely utilized for a variety of purposes, including retention of thermal energy in the pool water, prevention of debris collection in the pool, and aesthetics. Such pool covers, however, are not load-bearing to an extent to which the covers may be used as a floor surface to walk upon.

The term “load” as used herein is intended to mean a load representative of, for example, a weight of at least one adult human, such as a load density of 100 pounds per square foot. The term “self-supporting” as used herein is intended to mean a structure which is capable of supporting a load without substantially deviating from an unloaded configuration, without structural damage thereto, and/or without supportive aid from another structure throughout at least a substantial portion of a load support area of the load-bearing structure.

Some prior pool covers are capable of temporarily supporting a load to thereby provide a person sufficient time to escape from the pool cover before sinking into the pool. However, these covers are often damaged from the load and incapable of providing rigidity sufficient to accommodate high impact flooring for an indoor or outdoor sport court. The present invention provides a latch system for interlocking floor panels sufficient to support the load and rigors of a sport court flooring without having separation of the panels. The present invention further provides a load-bearing cover system involving a plurality of panels that may be coupled to one another and deployed as a cover, and may further be at least partially decoupled and stored in a compact vertically stacked arrangement. The load bearing cover or flooring of the present invention is further capable of deploying and retracting automatically and automatically coupling and decoupling adjacent panels in the deployment and retraction processes.

### SUMMARY

Embodiments according to aspects of the invention provide a latching system for stabilizing load bearing panel segments. The latching system retains adjacent panels with sufficient holding strength so that the panels resist separation or bending when the panels experience a load or impact. The latch system of the present invention is particularly well suited to retain adjacent panels when the panels are deployed and used as a sport court. The latch system is able to withstand separation even under heavy loads and impacts experienced from users jumping and running on the floor panels. In an exemplary embodiment of the invention the latching system includes a latch pin receiving housing having a housing aperture extending into the housing, wherein the housing aperture is adapted for receiving a latch pin. The housing is fixed to an end or edge of a panel and the latch pin is fixed to the end or edge of an adjacent panel. The latching system further includes an alignment guide, keyhole plate, lock bar and release lever contained within a void of the housing. The keyhole plate contained within the housing has a keyhole extending through the keyhole plate. The alignment guide couples the keyhole plate within the housing in a sliding relation to the housing. The lock bar is rotatably fixed within the housing. A free end portion of the lock bar is aligned with the keyhole of the keyhole plate. The release lever is fixed within the housing in pivoting relation to the housing and couples to the keyhole plate to actuate the keyhole plate.

In accordance with aspects of the invention the exemplary embodiment of the invention may further include a rear alignment plate coupled to a back portion of the housing. The rear alignment plate provides a pivot point for the release lever and the lock bar is pivotally attached to the rear alignment plate. The alignment guide may be formed within an alignment plate contained within the housing. The alignment plate includes an alignment aperture extending through the alignment plate that is aligned with the housing aperture of the housing. The keyhole plate may have a locking slot that engages with the latch pin to retain the latch pin in the housing. A spring retainer may couple with the housing and further a spring may be positioned between the spring retainer and a top portion of the keyhole plate. In this embodiment the spring applies a downward force on a top portion of the keyhole plate. In certain embodiments the spring retainer may be fixed to the alignment plate and the spring may be positioned between the spring retainer and a top portion of the keyhole plate. A spring may be engaged with the lock bar to apply a force against the lock bar to rotate the lock bar towards the keyhole. In certain embodiments the spring may be aligned between the rear alignment plate and the lock bar such that the spring applies a force against the lock bar to rotate the lock bar towards the keyhole. The lock bar may include a button extending outward from the lock bar. The button may be adapted to engage within a slot of the keyhole plate.

In an exemplary embodiment of the invention the latching system for stabilizing load bearing panel segments includes a latch pin receiving housing, an alignment plate, a keyhole plate, a lock bar, a release lever, and a rear alignment plate. The latch pin receiving housing has a housing aperture extending into the housing, wherein the housing aperture is adapted for receiving a latch pin. The alignment plate is contained within the housing. The alignment plate includes an alignment aperture extending through the alignment plate and is aligned with the housing aperture of the housing. The alignment plate further includes an alignment guide forming a portion of the alignment plate. The keyhole plate is contained within the housing and has a keyhole extending through the keyhole plate. The alignment guide of the alignment plate couples the keyhole plate to the alignment plate in sliding relation. The lock bar is contained within the housing, wherein a free end portion of the lock bar is aligned with the keyhole of the keyhole plate. The release lever couples to the keyhole plate to actuate the keyhole plate. Also, the rear alignment plate couples to a back portion of the housing. The rear alignment plate further provides a pivot point for the release lever and the lock bar is pivotally attached to the rear alignment plate.

In accordance with aspects of the invention this embodiment of the invention may further include a locking slot formed in the keyhole plate that engages with the latch pin. Also, a spring retainer may be fixed to the alignment plate and a spring may be positioned between the spring retainer and a top portion of the keyhole plate such that the spring applies a downward force on the keyhole plate. Further, a spring may be engaged with the lock bar, wherein the spring applies a force against the lock bar to rotate the lock bar towards the keyhole. Additionally, the spring may be aligned between the rear alignment plate and the lock bar, such that the spring applies a force against the lock bar to rotate the lock bar towards the keyhole.

In use, a latch pin is fixed to a first panel and the latching system is aligned and fixed to an adjacent panel. As the panels are slid towards each other the head of the latch pin enters the keyhole of the housing and presses against the lock bar. When the lock bar is pushed and rotated towards the rear of the housing the keyhole plate slides and the keyhole slot secures the latch pin within the housing. To disengage the panels, a force is applied to the release lever. The release lever slides the keyhole plate such that the head of the latch pin disengages from the keyhole slot and the latch pin may pull out of the keyhole.

The accompanying drawings, which are incorporated in and constitute a portion of this specification, illustrate embodiments of the invention and, together with the detailed description, serve to further explain the invention. The embodiments illustrated herein are presently preferred; however, it should be understood, that the invention is not limited to the precise arrangements and instrumentalities shown. For a fuller understanding of the nature and advantages of the invention, reference should be made to the detailed description in conjunction with the accompanying drawings.

### DESCRIPTION OF THE DRAWINGS

In the various figures, which are not necessarily drawn to scale, like numerals throughout the figures identify substantially similar components.

FIG. 1 is a perspective view of a floor panel locking latch of the present invention shown in a preload or released orientation;

FIG. 2 is a right side perspective view of a panel locking latch of the present invention shown in a loaded and locked orientation;

FIG. 3 is a left upper side perspective view of a panel locking latch of the present invention shown in a loaded and locked orientation;

FIG. 4 is a left lower side perspective view of a pane locking latch of the present invention shown in a loaded and locked orientation;

FIG. 5 is a left lower side perspective view of a panel locking latch of the present invention shown in a locked position without the latch pin;

FIG. 6 is an upper back perspective view of a panel locking latch of the present invention;

FIG. 7 is a lower back perspective view of a panel locking latch of the present invention;

FIG. 8 is a perspective view of a partial disassembled pane locking latch of the present invention;

FIG. 9 is perspective view of a panel locking latch of the present invention showing the latch pin in the loading position;

FIG. 10 is a perspective view of a panel locking latch of the present invention shown with the latch tube removed;

FIG. 11 is a partial sectional side perspective view of the panel locking latch of the present invention shown in the cocked or ready orientation;

FIG. 12 is a partial sectional side perspective view of the panel locking latch of the present invention shown in the loading orientation;

FIG. 13 is a partial sectional side perspective view of the panel locking latch of the present invention shown in the loaded orientation; and

FIG. 14 is a partial sectional side perspective view of the panel locking latch of the present invention shown in the locked and loaded orientation.

### DETAILED DESCRIPTION

The following description provides detail of various embodiments of the invention, one or more examples of which are set forth below. Each of these embodiments are provided by way of explanation of the invention, and not intended to be a limitation of the invention. Further, those skilled in the art will appreciate that various modifications and variations may be made in the present invention without departing from the scope or spirit of the invention. By way of example, those skilled in the art will recognize that features illustrated or described as part of one embodiment, may be used in another embodiment to yield a still further embodiment. Thus, it is intended that the present invention also cover such modifications and variations that come within the scope of the appended claims and their equivalents.

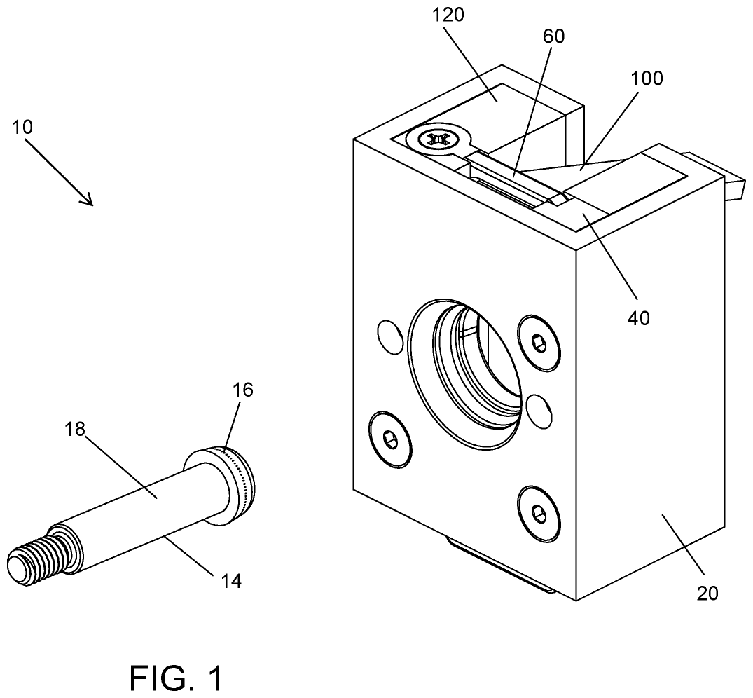

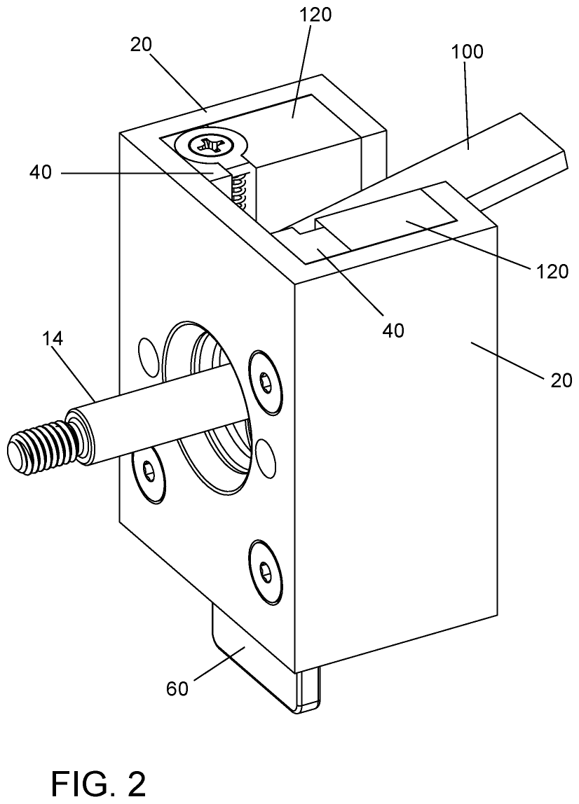

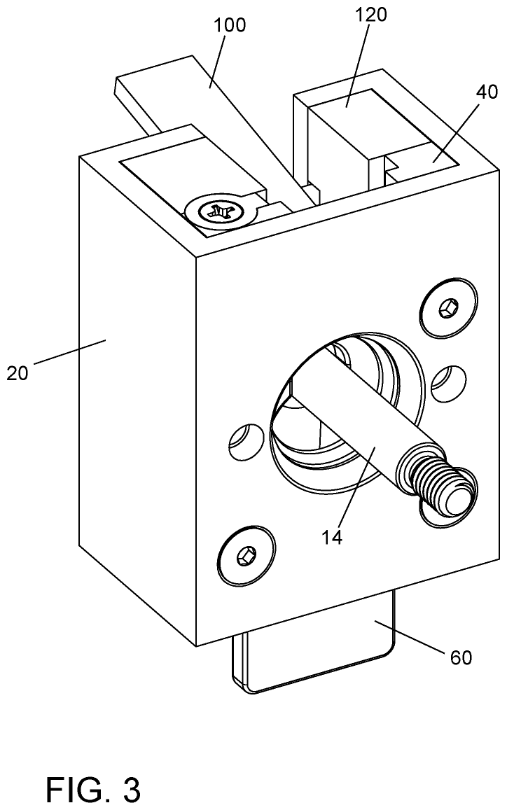

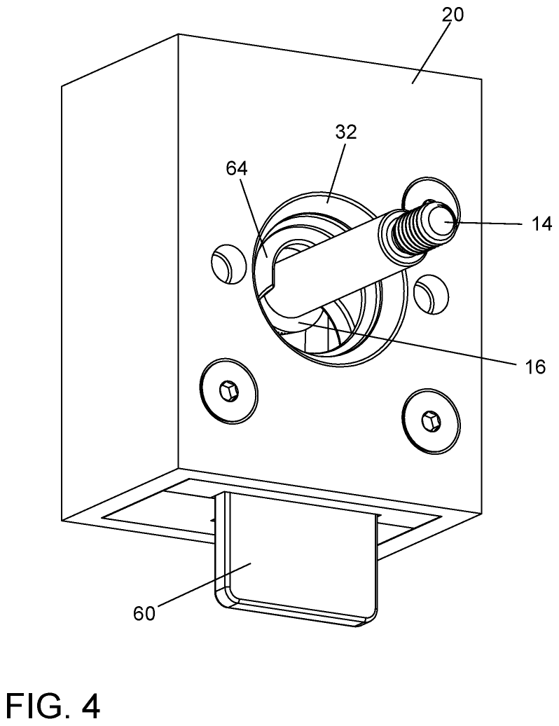

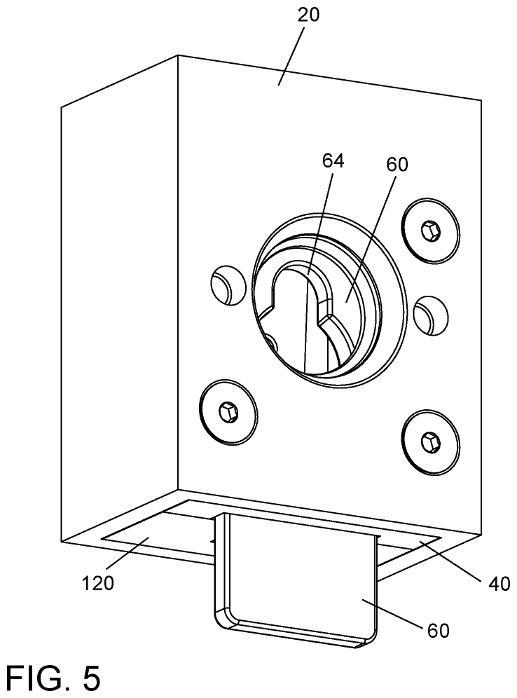

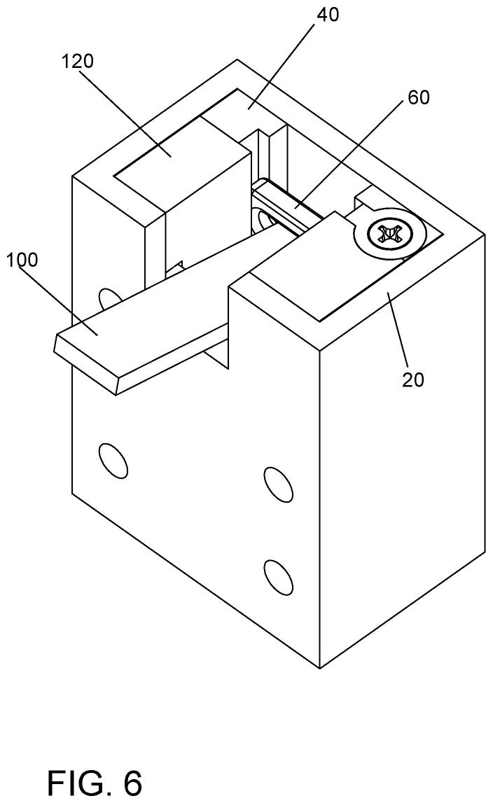

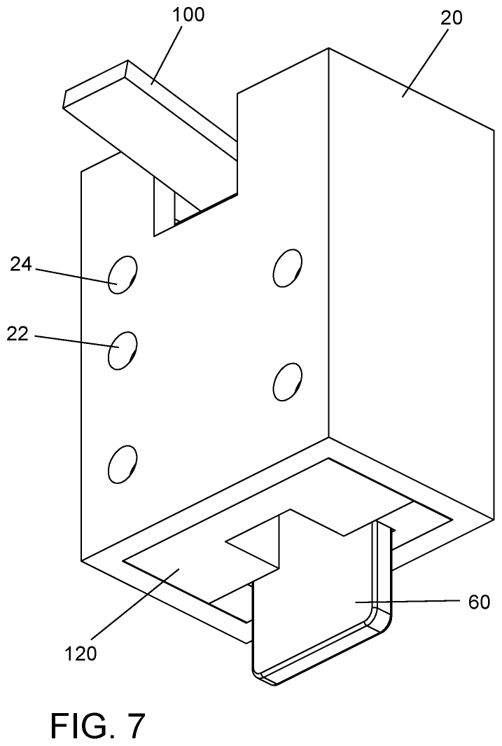

The modular floor panel or pool cover latch lock 10 of the present invention is particularly well suited for supporting loads and impacts against the panel. In an embodiment of the invention, the locking latch system 10 generally includes latch housing 20, alignment plate 40, keyhole plate 60, lock bar 80, release lever 100 and rear alignment plate 120 (see FIGS. 1-4). Latch pin 14 inserts into the housing 20 and the keyhole plate slides to lock the head 16 of the latch pin 14 within the housing. The key hole plate 60 includes a keyway or shoulder slot 64 that is sized slightly larger than a diameter of the shoulder 18 of the latch pin 14 (see FIGS. 3-5). The shoulder 18 of the latch pin slides within the keyway 64 and the head 16 engages a back side of the key hole plate 60. The keyhole plate is sufficiently thick so that an outward pulling force on the latch pin will not bed the keyhole plate a sufficient amount to pull the latch pin out of the locked keyhole plate. The release lever 100 slides the keyhole plate to the open position and releases the latch pin 14 from engagement with the key hole plate 60 (see FIGS. 6-7). The housing 20 and latch pin 14 may be mounted to the edge of a pool cover or flooring panel such that as two adjacent panels are moved together the latch pin enters a hole in the housing and engages with the key hole plate. The release lever may cooperate with an external roller, cam, catch or other trip mechanism to actuate the lever as the panel (and attached housing and lever) passes past the trip mechanism.

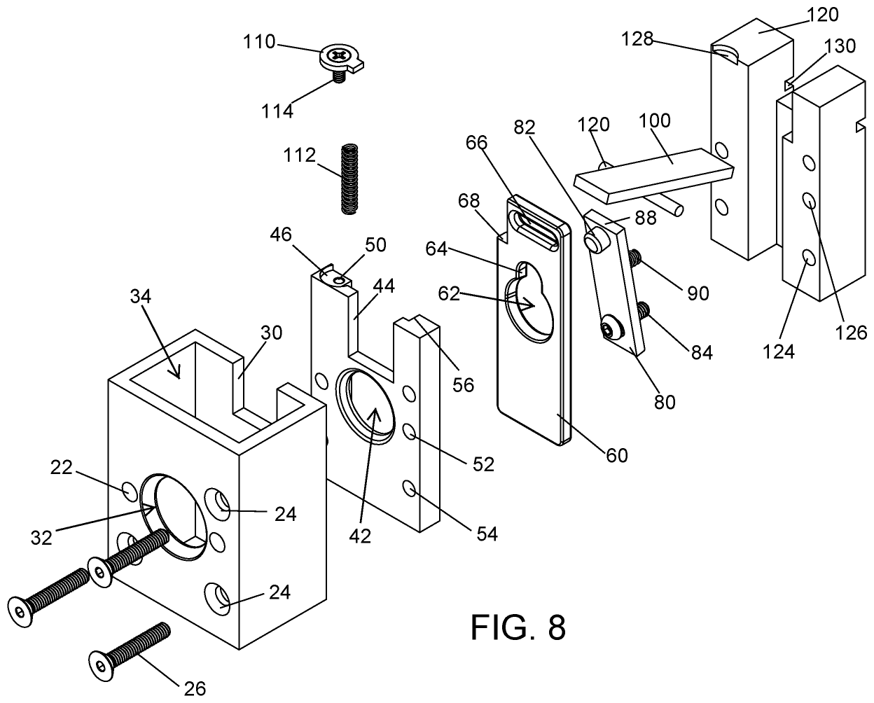

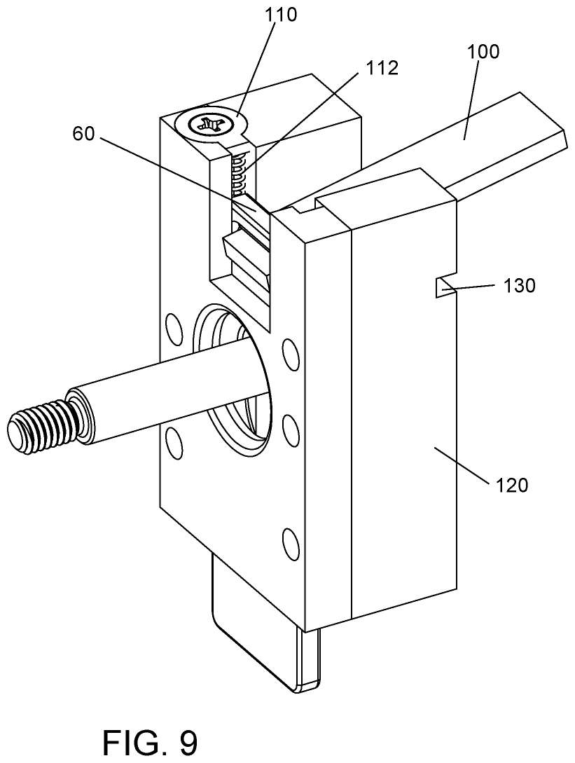

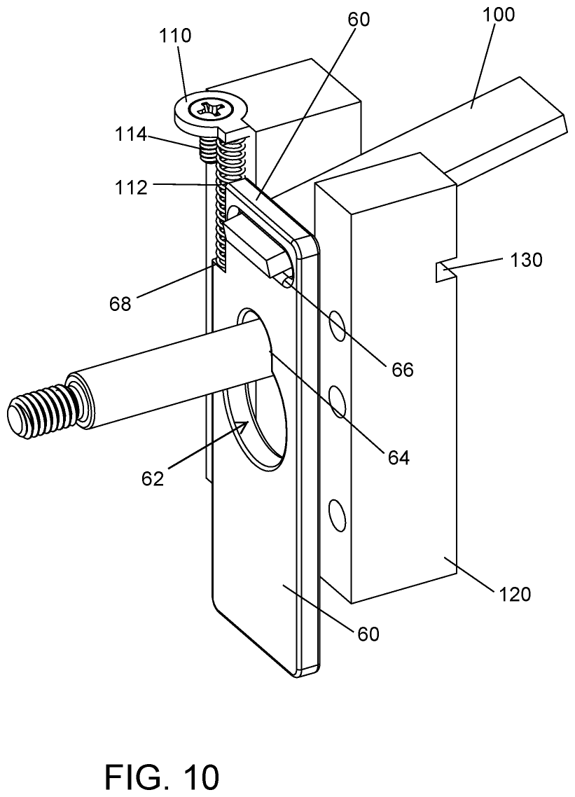

With reference to FIGS. 8-10, the components of the latching system will be described in greater detail. Latch housing 20 has a front, back, sides, an open top and bottom end and a hollow interior 34. Mounting holes 22 and assembly holes 24 extend through the front and back of the housing. The mounting holes may be threaded in the back of the housing. Alternatively, the assembly holes 24 may have clearance for a shoulder bolt to extend through the hole. Assembly screws 26 extend through the assembly holes and engage threaded assembly holes 24 formed in the back of the housing. Alternatively, the assembly holes 24 may have clearance for shoulder screws or stripper bolts extending through the assembly holes. Cinch nuts may be aligned with the assembly holes and pressed into the back of the housing for engagement with the stripper bolt. Mounting screws (not illustrated) extend through the mounting holes 22 of the housing and allow the user to mount the housing to an edge of a panel or other desired location. The back of the housing 20 further includes a cutout or lever slot 30 that allows the lever 100 to extend out of the housing through the slot 30. The front of the housing includes a latch pin hole 32. The diameter of the latch pin hole is larger than the diameter of the head 16 of the latch pin 14.

Alignment plate 40 is positioned within the housing 20 and includes mounting holes 52 and assembly holes 54 that align with mounting holes 22 and assembly holes 24 of housing 20. The mounting holes and assembly holes have clearance for the mounting screws and assembly screws to slide through the holes. Alignment plate 40 further includes a latch pin hole 42 that aligns with latch pin hole 32 formed in housing 20. A slot 44 is cut is a top portion of the plate and acts as clearance space for an end of the lever 100. A longitudinal slot or guide channels 56 are formed on a back side of the alignment plate 40 and are adapted for receiving the keyhole plate 60. A top end portion of the alignment plate may include recess 46 for spring retainer 110. Also, a threaded hole 50 may extend into the alignment plate 40 from the recess 46. Screw 114 engages with threaded hole 50 and may be used to secure the spring retainer 110 to the alignment plate 40. Those skilled in the art will appreciate that the front of housing 20 may be made thicker such that the alignment plate 40 may be formed as part of and integral with the housing 20. However, it will be appreciated that the cost to manufacturer such a housing will likely be more than manufacturing the housing and alignment plate separately.

Keyhole plate 60 includes a latch pin hole extending through the plate that has a diameter that is sized similar to the latch pin hole 42 of the latch pin plate 40 and the latch pin hole 32 of the housing 20. Shoulder slot or keyway 64 extends through the key hole plate 60 from a top portion of the latch pin hole 62. In this manner, the latch pin may extend through the hole 62 and the key hole plate 60 may slide down along the channel guides 56 of the alignment plate 40 such that the shoulder 18 of the latch pin 14 slides into the keyway 64. A lever arm channel extends through a top portion of the keyhole plate 60 and is adapted for receiving a portion of the lever 100 therethrough. A top side edge of the keyhole plate includes a spring stop 68. Spring 112 is sandwiched and held in place between the spring retainer 110 and spring stop 68.

Lock bar 80 is rotationally fixed to the rear retainer plate 120 or the rear wall of the housing 20. Lock bar 80 includes lock button 82 that is sized to fit within the keyway 64 of the keyhole plate 60. Lock bar 80 includes a top edge 88 that is separated a distance from the lock button 82. The top edge 88 engages against the keyhole plate 60 and stops rotation of the lock bar 80. A button screw 84 extends through an oversize hole 86 formed in the lock bar 80. The hole is oversized so that the lock bar may rotate within the confines of the screw 84. An end of Spring 90 engages within a recess 92 extending into the back side of the lock bar 80. The other end of spring 90 engages within recess 122 formed in the rear alignment plate 120. The spring provides tension to rotate the lock bar 80 towards the keyhole plate 60.

Rear alignment plate 120 includes assembly holes 124 and mounting holes 126 extending therethrough. The holes are aligned with corresponding holes in the alignment plate 40 and housing 20. The mounting holes and assembly holes have clearance for the mounting screws and assembly screws to slide through the holes. A top portion includes a recess that is adapted for receiving a portion of the spring retainer 110. A slot 130 is formed in the back of the rear alignment plate and is adapted for receiving a pivot pin 102 of release lever 100. Those skilled in the art will appreciate that the back of housing 20 may be made thicker such that the rear alignment plate 120 may be formed as part of and integral with the housing 20. In this embodiment the slot 130 may be a hole extending through the housing 20 and a pivot pin 102 may be removeable from the release lever 100. However, it will be appreciated that the cost to manufacturer such a housing will likely be more than manufacturing the housing and alignment plate separately.

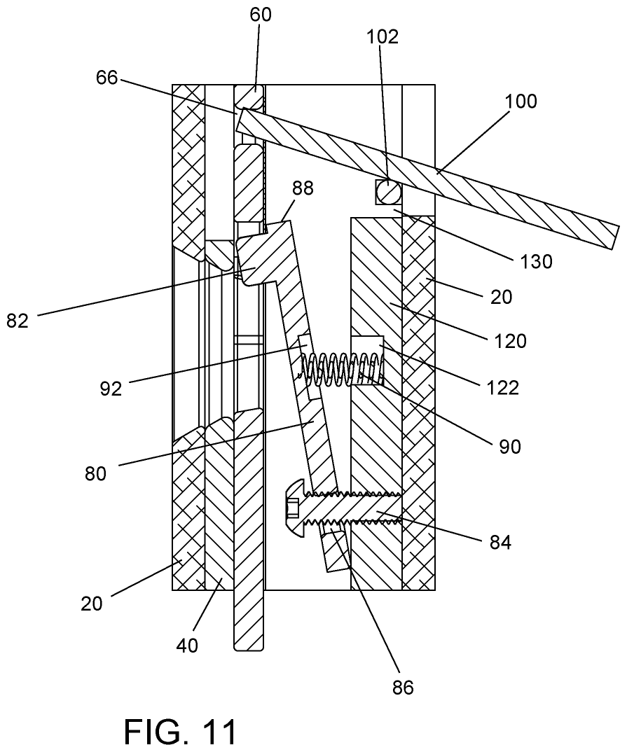

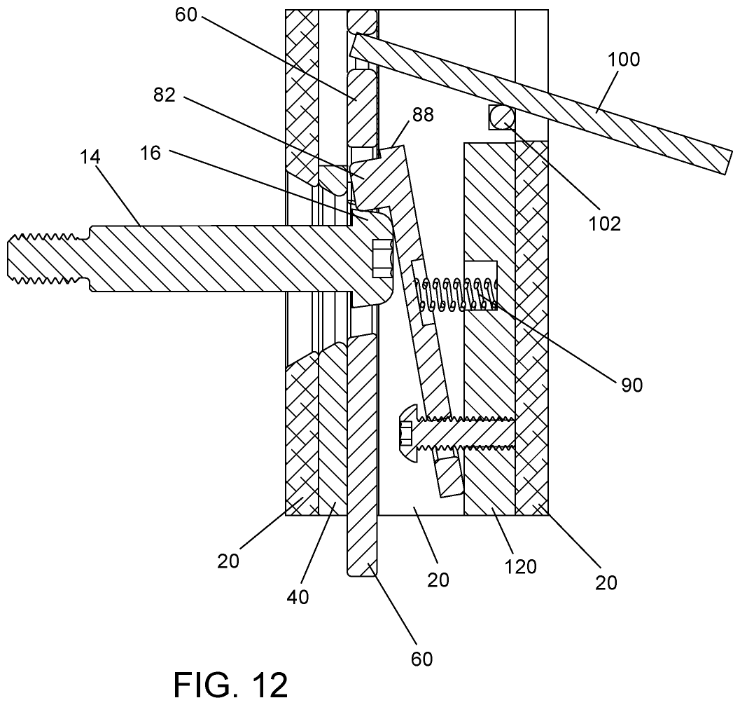

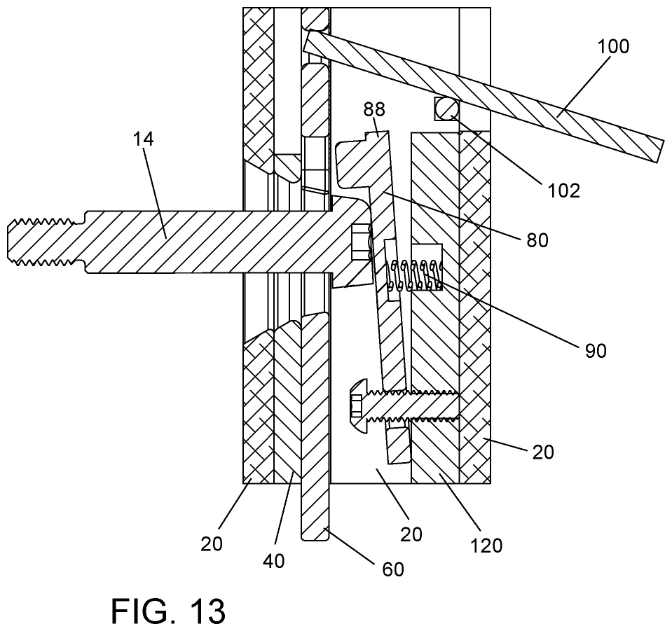

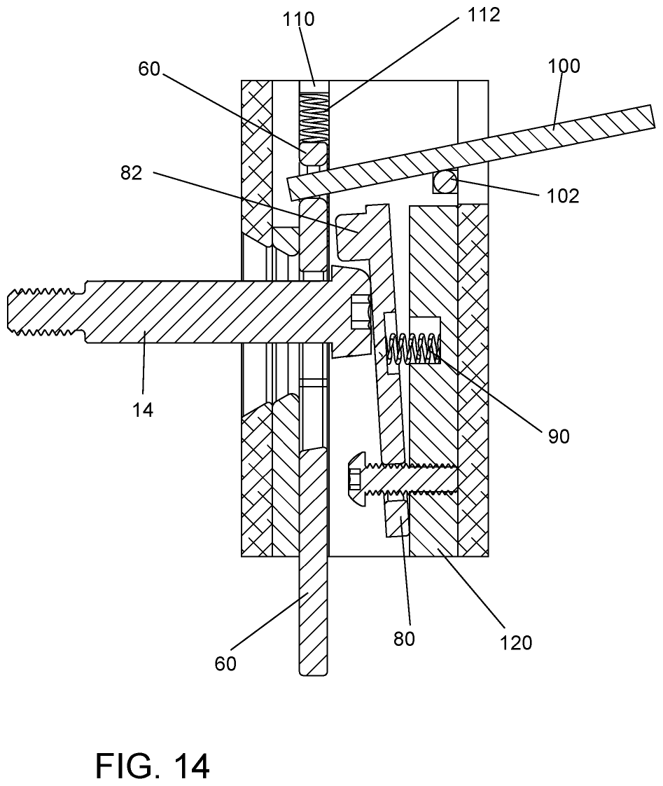

With reference to FIGS. 11-14 the actuation of lever 100, keyhole plate 60 and lock bar 80 is illustrated. When the free end of release lever 100 is in a downward position (see FIG. 11) the keyhole plate 60 is in a raised position, the 90 rotates the lock bar 80 towards the key hole plate 60 and, the lock button 82 is contained within keyway 64. When latch pin 14 extends into the housing 20 the head 16 of the pin 14 presses against the lock bar 80 and pushes the lock button 82 out of engagement with the keyway 64 (see FIGS. 12 and 13). When the latch pin pushes the lock bar out of engagement, spring 112 forces the key hole plate 60 downwards and free end of the release lever 100 rotates upwards. The keyway 64 surrounds a portion of the shoulder 18 of the latch pin 14 and the head 16 of the latch pin is retained behind the key hole plate 60 (see FIG. 14). In this manner the latch pin 14 is locked within the housing 20.

These and various other aspects and features of the invention are described with the intent to be illustrative, and not restrictive. This invention has been described herein with detail in order to comply with the patent statutes and to provide those skilled in the art with information needed to apply the novel principles and to construct and use such specialized components as are required. It is to be understood, however, that the invention can be carried out by specifically different constructions, and that various modifications, both as to the construction and operating procedures, can be accomplished without departing from the scope of the invention. Further, in the appended claims, the transitional terms comprising and including are used in the open ended sense in that elements in addition to those enumerated may also be present. Other examples will be apparent to those of skill in the art upon reviewing this document.

What is claimed is:

1. A device for stabilizing load bearing panel segments, the device comprising:
a latch pin receiving housing having a housing aperture extending into the housing, wherein the housing aperture is adapted for receiving a latch pin;
an alignment guide within the housing;
a keyhole plate contained within the housing and having a keyhole extending through the keyhole plate, wherein the alignment guide couples the keyhole plate within the housing in a sliding relation to the housing;
a lock bar rotatably fixed within the housing, wherein a free end portion of the lock bar is aligned with the keyhole of the keyhole plate;
a release lever fixed in pivoting relation to the housing and coupled to the keyhole plate to actuate the keyhole plate.

2. The device as recited in claim 1, further including a rear alignment plate coupled to a back portion of the housing, the rear alignment plate further providing a pivot point for the release lever, and further wherein the lock bar is pivotally attached to the rear alignment plate.

3. The device as recited in claim 1, wherein the alignment guide is formed within an alignment plate contained within the housing, the alignment plate including an alignment aperture extending through the alignment plate and aligned with the housing aperture of the housing.

4. The device as recited in claim 1, wherein keyhole plate further includes a locking slot that engages with the latch pin.

5. The device as recited in claim 1, further including a spring retainer coupled with the housing and further including a spring positioned between the spring retainer and a top portion of the keyhole plate, wherein the spring applies a downward force on a top portion of the keyhole plate.

6. The device as recited in claim 3, further including a spring retainer fixed to the alignment plate and a spring positioned between the spring retainer and a top portion of the keyhole plate, wherein the spring applies a downward force on a top portion of the keyhole plate.

7. The device as recited in claim 1, further including a spring engaged with the lock bar, wherein the spring applies a force against the lock bar to rotate the lock bar towards the keyhole.

8. The device as recited in claim 2, further including a spring aligned between the rear alignment plate and the lock bar, wherein the spring applies a force against the lock bar to rotate the lock bar towards the keyhole.

9. The device as recited in claim 8, wherein the lock bar includes a button extending outward from the lock bar.

10. A device for stabilizing load bearing panel segments, the device comprising:
a latch pin receiving housing having a housing aperture extending into the housing, wherein the housing aperture is adapted for receiving a latch pin;
an alignment plate contained within the housing, the alignment plate including an alignment aperture extending through the alignment plate and aligned with the housing aperture of the housing; the alignment plate further including an alignment guide forming a portion of the alignment plate;
a keyhole plate contained within the housing and having a keyhole extending through the keyhole plate, wherein the alignment guide of the alignment plate couples the keyhole plate to the alignment plate in sliding relation;
a lock bar contained within the housing, wherein a free end portion of the lock bar is aligned with the keyhole of the keyhole plate;
a release lever coupled to the keyhole plate to actuate the keyhole plate; and
a rear alignment plate coupled to a back portion of the housing, the rear alignment plate further providing a pivot point for the release lever, and further wherein the lock bar is pivotally attached to the rear alignment plate.

11. The device as recited in claim 10, wherein the keyhole plate further includes a locking slot that engages with the latch pin.

12. The device as recited in claim 10, further including a spring retainer fixed to the alignment plate and a spring positioned between the spring retainer and a top portion of the keyhole plate, wherein the spring applies a downward force on the keyhole plate.

13. The device as recited in claim 10, further including a spring engaged with the lock bar, wherein the spring applies a force against the lock bar to rotate the lock bar towards the keyhole.

14. The device as recited in claim 10, further including a spring aligned between the rear alignment plate and the lock bar, wherein the spring applies a force against the lock bar to rotate the lock bar towards the keyhole.

15. The device as recited in claim 14, wherein the lock bar includes a button extending outward from the lock bar.
